(19) United States
(12) Patent Application Publication
(10) Pub. No.: US 2026/0252945 A1
(43) Pub. Date: Aug. 27, 2026

(54) AUTOMATED SYMMETRY VERIFICATION USING ALGORITHM-SPECIFIC SYMMETRIES FOR ERROR MITIGATION IN QUANTUM COMPUTATIONS

(71) Applicant: IonQ, Inc., College Park, MD (US)

(72) Inventor: Andrii MAKSYMOV, Hyattsville, MD (US)

(21) Appl. No.: 19/548,608

(22) Filed: Feb. 24, 2026

Related U.S. Application Data
(60) Provisional application No. 63/762,577, filed on Feb. 24, 2025.

(51) Int. Cl. G06N 10/70; G06N 10/20

(52) U.S. Cl. CPC G06N 10/70; G06N 10/20

(57) ABSTRACT

Aspects of the present disclosure relate generally to systems and methods for use in the implementation and/or operation of quantum information processing (QIP) systems, and more particularly, to the use of performing automated symmetry verification on a quantum circuit. An exemplary method includes obtaining a quantum circuit with a compiled quantum program corresponding to a defined quantum computation; determining types of gates implemented on the quantum circuit; tracking allowed output states of the quantum circuit from an initial state based on the determined type of gates implemented on the quantum circuit; and detecting an error in the quantum circuit by identifying a possible output state that does not correspond to the subset of allowed output states.

### CROSS REFERENCE TO RELATED APPLICATIONS

This application claims priority to U.S. Provisional Patent Application No. 63/762,577, filed February 24, 2025, the entire contents of which are hereby incorporated by reference.

### TECHNICAL FIELD

Aspects of the present disclosure relate generally to systems and methods for use in the implementation, and/or operation of quantum information processing (QIP) systems.

### BACKGROUND

Trapped atoms are one of the leading implementations for quantum information processing or quantum computing. Other implementations include those based on superconducting qubits or photonic qubits, for example. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of methods and systems for utilizing symmetry verification using algorithm-specific symmetries to post-select erroneous bit strings. Specifically, the present disclosure describes a method to automate circuit exploration for any symmetry restrictions imposed on the Hilbert space that can be used in post-processing to eliminate errors through symmetry verification.

In an exemplary aspect, the system and method described herein is configured to perform automated symmetry verification on a quantum circuit. In an exemplary aspect, the method includes: obtaining a quantum circuit with a compiled quantum program corresponding to a defined quantum computation; determining types of gates implemented on the quantum circuit; tracking allowed output states of the quantum circuit from an initial state based on the determined type of gates implemented on the quantum circuit by: re-mapping and/or generating a possible output states according to operations performed for each type of gate implemented on the quantum circuit, wherein each operation starts with initiating an initial classical state of zero states, and tracking each generated possible output state when performing an operation corresponding to each type of gate implemented on the quantum circuit to determine a subset of possible output states; and detecting an error in the quantum circuit by identifying a possible output state that does not correspond to the subset of allowed output states.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 a view of atomic ions in a linear crystal or chain in accordance with aspects of this disclosure.

FIG. 2 an example of a quantum information processing (QIP) system in accordance with aspects of this disclosure.

FIG. 3 an example of a computer device in accordance with aspects of this disclosure.

FIG. 4 a first example of performing automated symmetry verification on a quantum circuit in accordance with aspects of this disclosure.

FIG. 5 a second example of performing automated symmetry verification on a quantum circuit in accordance with aspects of this disclosure.

FIG. 6 a third example of performing automated symmetry verification on a quantum circuit in accordance with aspects of this disclosure.

FIG. 7 an example of a method performing automated symmetry verification on a quantum circuit in accordance with aspects of this disclosure.

FIG. 8 an example of a QIP system in accordance with aspects of this disclosure.

Like reference numbers and designations in the various drawings indicate like elements.

### DETAILED DESCRIPTION

The detailed description set forth below in connection with the appended drawings or figures is intended as a description of various configurations or implementations and is not intended to represent only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Large quantum computers promise to solve critical problems that are not solvable otherwise. However, modern quantum technologies suffer various imperfections such as control errors and qubit decoherence, inhibiting their potential utility. The overheads of uantum error correction are too great for near-term quantum computers, whereas error-mitigation strategies that address specific device imperfections may lose relevance as devices improve. Error mitigation is an umbrella term for a wide variety of strategies that are used to improve device performance but are not scalable (i.e, they require resources that asymptotically scale exponentially with the number of qubits in the system and the error rates). To enhance the performance of quantum computers with high-quality qubits, the present disclosure describes an error mitigation strategy based on symmetrization and nonlinear aggregation.

Symmetrization refers to hardware (such as qubit to ion assignment or gate to pulse conversion) and algorithmic (such as operation decomposition to native gates) error mitigation strategy. The ultimate goal of error mitigation strategy is to diversify hardware-level error propagation through to reduce their cumulative effect. To avoid qubit- and gate-level overhead, it distinguishes the ideal quantum computation by its invariance under certain symmetries that arise at multiple levels of physical implementation.

Symmetries of a given Hamiltonian are known before being mapped onto qubits. However, unless provided by a user, it may be difficult to identify the symmetries at a circuit level. Yet, certain symmetries may still be automatically identified, particularly when circuits are expressed using high-level primitives. High-level primitives encapsulate complex operations into more manageable and re-usable components, thereby enhancing the efficiency and effectiveness of quantum circuit development. Specifically, the high-level primitives simplify the design and implementation of quantum algorithms by providing a higher level of abstraction, allowing developers to focus on the algorithmic logic rather than the low-level details of gate operation.

In some aspects, for Variational Quantum Eigensolver (VQE) circuits and other chemistry circuits, the present disclosure describes determining a subset of allowed output states based on an initial classical state and following excitation terms. Specifically, the present disclosure describes automating circuit exploration for any symmetry restrictions imposed on the Hilbert space that can be used in post-processing to eliminate errors through symmetry verification.

VQE is a hybrid quantum-classical algorithm used to find the ground state energy of a quantum system, which is a fundamental problem in quantum chemistry and materials science. The VQE algorithm leverages both quantum and classical resources to optimize a parameterized quantum circuit to approximate the ground state of a given Hamiltonian. By using a parameterized quantum circuit and classical optimization techniques, VQE provides a practical approach to tackling complex quantum problems with current and near-term quantum hardware. As an example, VQE is widely used in quantum chemistry problems to calculate the ground energies of molecules, which is crucial for understanding chemical reactions and properties. VQE may also be used in materials science to study properties of materials by finding the ground state energies of complex Hamiltonians.

The VQE algorithm uses a parameterized quantum circuit, often referred to as an ansatz, to represent the quantum state. The ansatz is designed to be flexible and capable of representing the ground state of the Hamiltonian. The parameters of the ansatz are adjusted to minimize the expectation value of the Hamiltonian. The Hamiltonian represents the total energy of the quantum system. In the context of VQE, it is typically expressed as a sum of Pauli operators. The goal is to find a minimum eigenvalue (ground state energy) of this Hamiltonian. A classical optimizer is used to iteratively adjust the parameters of the quantum circuit to minimize the expectation value of the Hamiltonian. The optimization process involves evaluating the expectation value of the Hamiltonian for different sets of parameters and updating the parameters based on the optimization algorithm. The quantum circuit is then executed on a quantum computer, and measurements are performed to estimate the expectation value of the Hamiltonian. These measurements provide the feedback needed for the classical optimizer to update the parameters.

The symmetry verification approach described in the present disclosure provides a tangible improvement to the technical field of quantum information processing (QIP). For example, symmetry verification is a powerful tool for enhancing the accuracy and reliability of quantum computations. By identifying and discarding erroneous bit strings, the present disclosure improves the fidelity of quantum results, optimizes resource usage, and enhances the performance of quantum algorithms. This approach is particularly valuable in the era of noisy intermediate-scale quantum (NISQ) devices, where error management is a critical challenge.

Automated symmetry verification offers several advantages in quantum computing by enhancing accuracy, efficiency, and error mitigation. By leveraging known symmetries in quantum circuits, the present disclosure effectively filters out erroneous bit strings, improving computational precision. It automates the identification of symmetries, even when they are not explicitly provided, particularly in circuits utilizing high-level primitives. This approach treamlines post-processing by narrowing the number of possible output states, reducing computational complexity while maintaining valid quantum states. Additionally, the present disclosure optimizes circuit exploration by systematically enforcing symmetry restrictions, ensuring efficient computation. The method is highly versatile, applying to various quantum operations such as single-qubit rotations, CNOTs, SWAPs, and Fermi excitations. By continuously tracking and validating quantum states, automated symmetry verification prevents the inclusion of physically invalid results, making it a powerful tool for improving quantum algorithm reliability and performance.

Further, the symmetry verification approach in accordance with this disclosure can be applicable to multiple types of QIPs and qubit technologies. While various aspects of the symmetry verification approach are described with reference to a QIP system based on trapped atom qubits, the disclosure is not limited in that respect. Instead, the symmetry verification approach may be used in other types of QIP systems based on solid-state qubit.

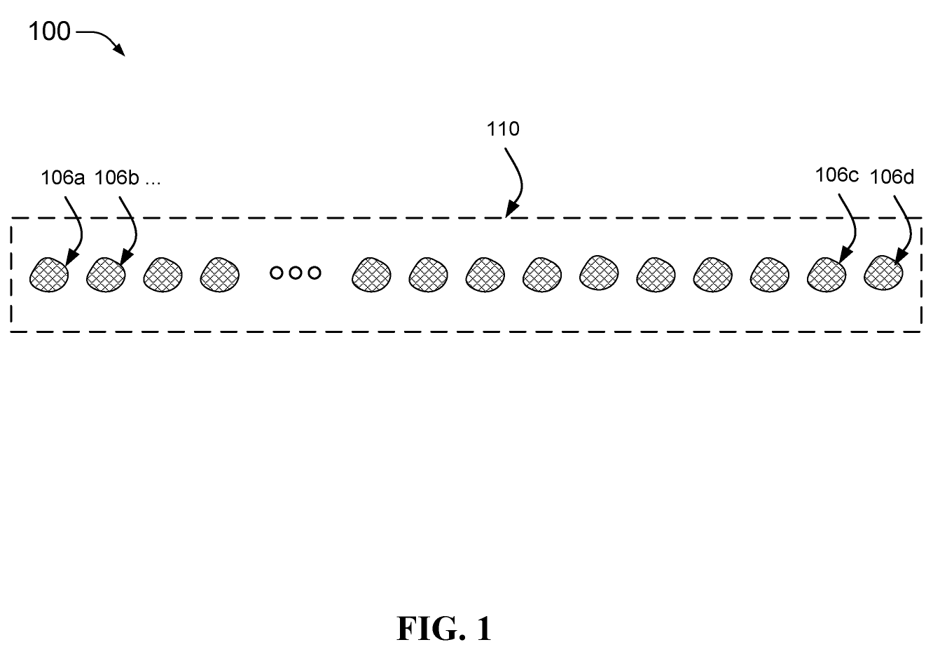

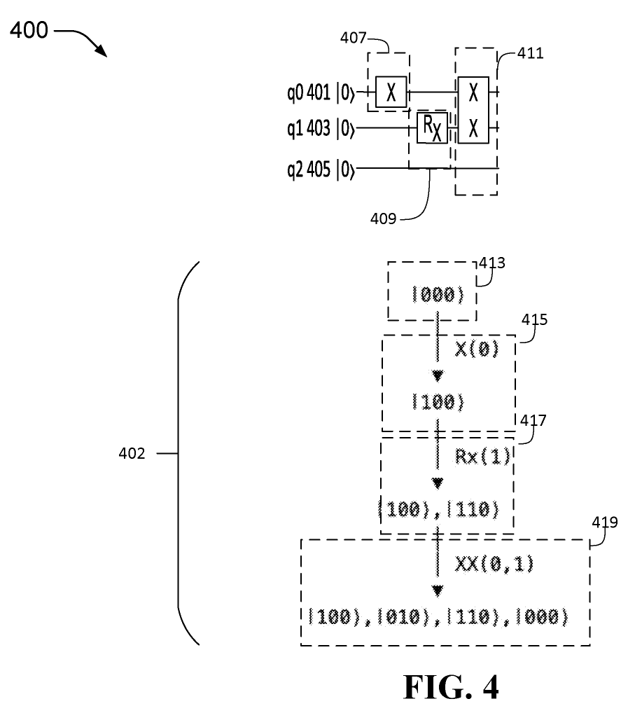

Solutions to the issues described above are explained in more detail in connection with FIGS. 1-7, with FIGS. 1-3 providing a general disclosure of QIP systems or quantum computers, and more specifically, of atomic based QIP systems or quantum computers, FIGS. 4-7 provide descriptions and examples of implementing and utilizing symmetry verification using algorithm-specific symmetries to post-select erroneous bit strings, in accordance with various example aspects of the present disclosure.

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

For illustrative purposes only, the present disclosure may describe the technology as applied to ion trapped technology. However, it should be noted that the present disclosure is not only limited to ion trapped technology and can be used with any quantum computing technologies.

Atomic quantum computers can include array(s) of atoms or ions trapped, for example, inside a vacuum chamber. A size and dimensionality of atomic arrays may vary.

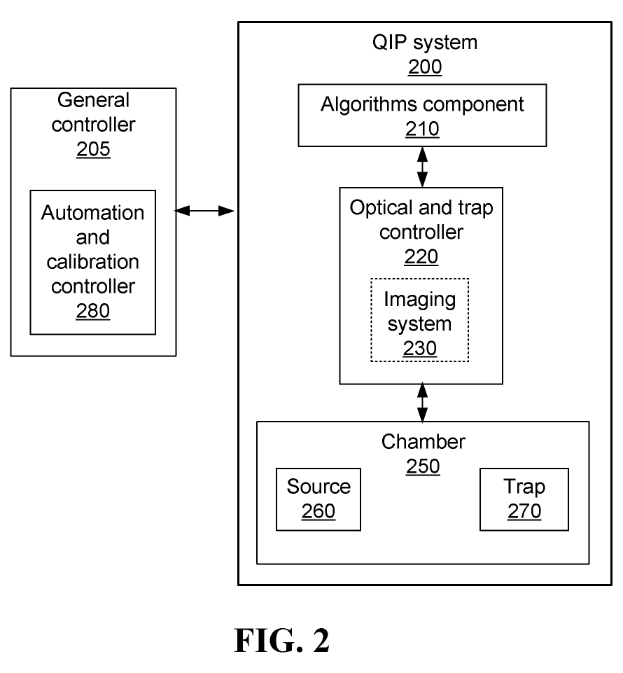

FIG. 1 illustrates a diagram 100 with multiple atomic ions or ions 106 (e.g., ions 106a, 106b, …, 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be ytterbium ions (e.g., 171b+ons), for example. The ions are illuminated with laser (optical) radiation tuned to a resonance in 171b+nd the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to ytterbium ions, barium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

The chain 110 of ions 106 may be part of a QPU, that is, the chain 110 of ions 106 may be part of a processing engine or processing core of a QIP system. When any one of the ions 106 is capable of being connected to any other ion 106 in the chain 110, the chain 110 is considered to be fully connected, and thus, it can be used to implement a fully connected QPU. Fully connected QPUs need not be limited to atomic-based QIP systems.

FIG. 2 ilustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations, and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using one or more of the general controller 205, the automation and calibration controller 280, the optical and trap controller 220, and the chamber 250.

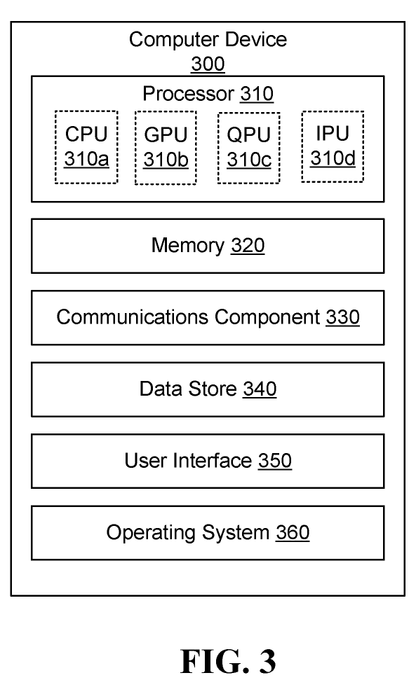

Referring now to FIG. 3 an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system configured to perform quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit echnologies. One or more of the QPUs 310c may be fully connected QPUs in accordance with aspects of this disclosure.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, data store 340 may be a data repository for operating system 360 (e.g., classical OS, or quantum OS, or both). In one implementation, the data store 340 may include the memory 320. In an mplementation, processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of operating system 360. When the computer device 300 is implemented as part of a cloud-based infrastructure solution, the user interface component 350 may be used to allow a user of the cloud-based infrastructure solution to remotely interact with the computer device 300.

The present disclosure may describe methods and systems implemented on ion traps in FIGS. 1-3 for illustrative purposes only, it should be noted that the methods and systems described in the present disclosure may be applied to other quantum computing technologies. As a non-limiting example in the context of quantum circuits, verifying symmetry can be challenging due to the inherent complexities of quantum evolution and measurement constraints. An example of a verifiable symmetry is particle conservation, which imposes strict limitations on the number of accessible quantum states when the initial state is known. This principle ensures that the total number of particles remains unchanged throughout the quantum process, effectively reducing the possible state space and providing a more tangible means of symmetry verification compared to more abstract symmetries that may not be directly observable in a quantum circuit. In this way, there are symmetries in the algorithm that would not allow a mapping to observe certain outcomes or bit strings. For example, if there are no errors, then a particular bit string that is known to be forbidden in the algorithm will not be observed.

In connection with the systems described in FIGS. 1-3, a technique or method for performing automated symmetry verification on a quantum circuit is described. Specifically, he present disclosure describes a method of automating circuit exploration for any symmetry restrictions imposed on the Hilbert space that can be used in post-processing to eliminate errors through symmetry verification. The systems described in FIGS. 2 and/or FIG. 3 may be used to control various aspects of the QIP system as described below.

For VQE circuits, the present disclosure describes the following operations based on the type of gates implemented in the quantum circuit. In some aspects, when a particular type of gate or operation is encountered in the quantum circuit, a particular operation is applied to remap and/or add allowed states may be applied based on the operation for the particular type or gate or operation. The operations to be implemented based on the detected gate type of gate/operation (also generally referred to as a “gate type” or “operation type”) is listed below.

Rule 1: Single-qubit π-rotations such as X and Y gates or Gate PI (GPI) gates do not increase the number of states (e.g., no branching) and only remap the existing states by flipping the bit on the corresponding ion (e.g., performing a full flip). Gate PI means a single-qubit gate that performs a single-qubit rotation by angle pi about an arbitrary axis in the XY plane. Z gates may be ignored because they may change phase but do not add any new bit strings.

Rule 2: ingle-qubit non-π gates such as Rx, Ry, R, or U3 (native G PI/2 (GPI2)) add a complementary state with a bit flipped on the corresponding qubit. GPI2 corresponds to a single-qubit rotation by angle pi/2 around the specified axis in the XY plane.

Rule 3: wo-qubit XX, YY, or MS gate, which cannot be reduced to single-qubit gates (e.g. XX(pi) can be implemented as two single-qubit X gates), add a complementary state with bits simultaneously flipped on the target qubits.

Rule 4: auli evolutions add a complementary state with qubits simultaneously flipped on qubits that correspond to X and Y.

Rule 5: NOTs and multi-controlled X or Y gates do not add new states, but flip target bits conditioned on the state of control bits.

Rule 6: WAPs do not add new states, but swap bits on the target ions in each state.

Rule 7: ivens rotations add complementary states with bits simultaneously flipped on target qubits if particle preservation is obeyed. As an example, for two-qubit Givens rotation states 00 and 11 are preserved but 01 is flipped to 10 and vice versa.

Rule 8: Fermi excitations act as their underlying Givens rotations. In addition, all Z terms may be ignored.

Generally, the automated algorithm starts with all-zero initial state. Any other state has to be prepared, which is included as part of the submitted computation. The automated algorithm then remaps and compliments the list of tracked states based on the operation rules given above. Depending on what operations are performed, the present disclosure derives states that are allowed and states that are not allowed for the quantum circuit.

It should be noted that the rules and corresponding rule numbers are listed for reference only and other rules and numbers may be implemented.

FIG. 4 llustrates a first example of performing automated symmetry verification on a quantum circuit in accordance with aspects of this disclosure. The first example 400 covers operations: Rule 1, Rule 2, and Rule 3.

As an example, the first example 400 shown in FIG. 4 includes a quantum circuit having three qubits 401, 403, 405 with an X-gate 407, a Rxate 409, and a two-qubit XX gate 411. First, the X-gate 407 (e.g., a Pauli-X gate or NOT gate) is applied to the first qubit 401. This gate flips the state of the qubit from |0⟩ to |1⟩ or from |1⟩ to |0⟩. Second, the Rxate is applied to the second qubit 403 and represents a rotation around the X-axis by an angle θ. Third, a two-qubit XX gate is applied to between the first qubit 401 and the second qubit 403. The two-qubit XX gate corresponds to an interaction term that involves both qubits.

Accordingly, the first example 400 will perform the following operations in order based on the different types of gates that are encountered in order. As an initial matter, the example 402 begins with an initial classical state 413, which is usually just the all-zero state. For example, example 402 starts with the initial state of |000⟩ 413. It is noted that according to an exemplary aspect, the initial classical state 413 can be a single classical bitstring with all qubits initialized to zero (i.e., the all-zeros state). Moreover, this initialization will typically be performed once at the start of the tracking process rather than being repeated for each gate operation in the exemplary aspect.

As next shown in 415, the example 402 encounters X-gate 407 so the example 402 will apply Rule 1 (e.g., single-qubit π-rotations do not increase the number of states and only remaps the existing states by flipping the bit on the corresponding ion). For example, in 415, er Rule 1, the existing state (e.g., the initial classical state) of |000⟩ is remapped by flipping the bit on the corresponding ion to |100⟩ since the X-gate 407 is applied to the first qubit 401.

As shown in 417, the example 402 encounters a Rxate so the example 402 will apply Rule 2 (e.g., single-qubit non-π gates add a complementary state with a bit flipped on the corresponding qubit) to the existing state of |000⟩ 413. For example, in 417, per Rule 2, example 402 adds an allowable state of |110⟩ by flipping the bit on the existing state of |100⟩ to |110⟩ based on the Rx gate being applied to the second qubit 403.

As shown in 419, the example 402 encounters a XX gate 411 between the first qubit 401 and the second qubit 403, so the example 402 will apply Rule 3 (e.g., two-qubit XX gate adds an allowable state with bits simultaneously flipped on the target qubits) to the existing states of |100⟩ and |110⟩. For example, in 419, per Rule 3, the example 402 adds an allowable state to |100⟩ by flipping the bits on the first qubit 401 and the second qubit 403 to generate the complementary state of |010⟩ and the example 402 adds an allowable state of |110⟩ by flipping the bits on the first qubit 401 and the second qubit 403 to generate the complementary state of |000⟩.

Accordingly, example 402 reveals that the allowed states in the quantum circuit are: |100⟩, |010⟩, |110⟩, and |000⟩. In other words, the example 402 identifies that there are four allowed states out of eight (e.g., 23allowed states after starting with all zero states, going through every operation according to the rules, and tracking each state. It should be noted that the example 402 does not determine the probability of any of the allowed states, but, instead, reveals that there are four allowed states of |100⟩, |010⟩, |110⟩, and |000⟩ in the circuit.

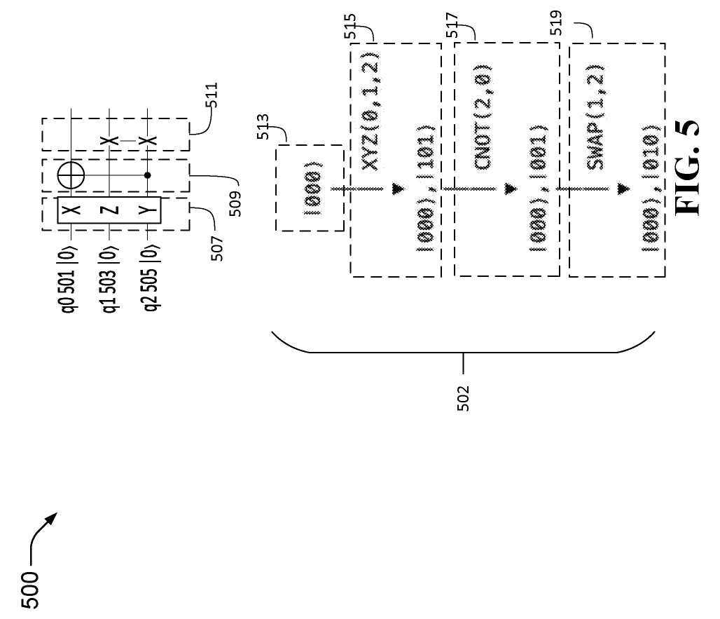

FIG. 5 llustrates a second example of performing automated symmetry verification on a quantum circuit in accordance with aspects of this disclosure. The second example 500 covers operations: Rules 4, 5, and 6.

As an example, the second example 500 shown in FIG. 5 includes a quantum circuit having three qubits 501, 503, 505 with a Pauli string 507, a CNOT gate 509, and a SWAP gate 511. First, the Pauli string 507 is applied to the first qubit 501, the second qubit 503, and the third qubit 505. The Pauli string typically refers to a sequence of Paul operators (I, X, Y, Z) applied to specific qubits. Second, the CNOT gate 509 is applied to the third qubit 505 and the first qubit 501. The CNOT gate 509 is a two-qubit gate where one qubit acts as a control (e.g., first qubit 501) and the other is a target (e.g., third qubit 501) such that the operation flips the arget qubit (e.g., the first qubit 501) if the control qubit (e.g., third qubit 505) is in the state |1⟩. Third, a SWAP gate 511 is applied to the second qubit 503 and the third qubit 505. The SWAP gate exchanges the states of two qubits such that the quantum states of each qubit are exchanged.

Accordingly, the second example 500 will perform the following operations in order based on the different types of gates that are encountered in order. As an initial matter, example 502 begins with an initial classical state, which is usually just the all-zero state in 513. For example, example 502 starts with the initial state of |000⟩ 513. It is again noted that according to an exemplary aspect, the initial classical state 513 can be a single classical bitstring with all qubits initialized to zero (i.e., the all-zeros state). Moreover, this initialization will typically be performed once at the start of the tracking process rather than being repeated for each gate operation in the exemplary aspect.

As shown in 515, the example 502 encounters the Pauli string 507 so the example 502 will apply Rule 4 (e.g., Pauli strings add an allowed state with qubits simultaneously flipped on qubits that correspond to X and Y.). For example, in 515, per Rule 4, the existing state (e.g., the classical state) of |000⟩ adds a complementary state of |101⟩ by simultaneously flipping the bits on qubits that correspond to X (e.g., first qubit 501) and Y (e.g., third qubit 505).

As shown in 517, the example 502 encounters a CNOT gate 517 so the example 502 will apply Rule 5 (e.g., CNOTs do not add new states, but flip target bits conditioned on the state of control bits) to the existing states of |000⟩ and |101⟩.For example, in 517, per Rule 5, the example 502 does not add new states, but flips target bits conditioned on the state of control bits such that |101⟩ is re-mapped to |001⟩ because the control bit is on the first qubit 501.

As shown in 519, example 502 encounters a SWAP gate 511 so the example 502 will apply Rule 6 (e.g., SWAPs do not add new states, but swap bits on the target ions in each state) to the existing states of |001⟩. For example, in 519, per Rule 6, the example 502 does not add any new states but swaps bits on the target ions in each state such that |001⟩ is re-mapped to |010⟩ since the target ions are on the first qubit 503 and the third qubit 505.

Accordingly, example 502 reveals that the allowed states in the quantum circuit are: |000⟩ and |010⟩. In other words, the example 502 identifies that there are two allowed states out of eight (e.g., 23allowed states after starting with all zero states, going through every operation according to the rules, and tracking each state. It should be noted that the example 02 does not determine the probability of any of the allowed states, but, instead, reveals that there are two allowed states of |000⟩ and |010⟩ in the circuit.

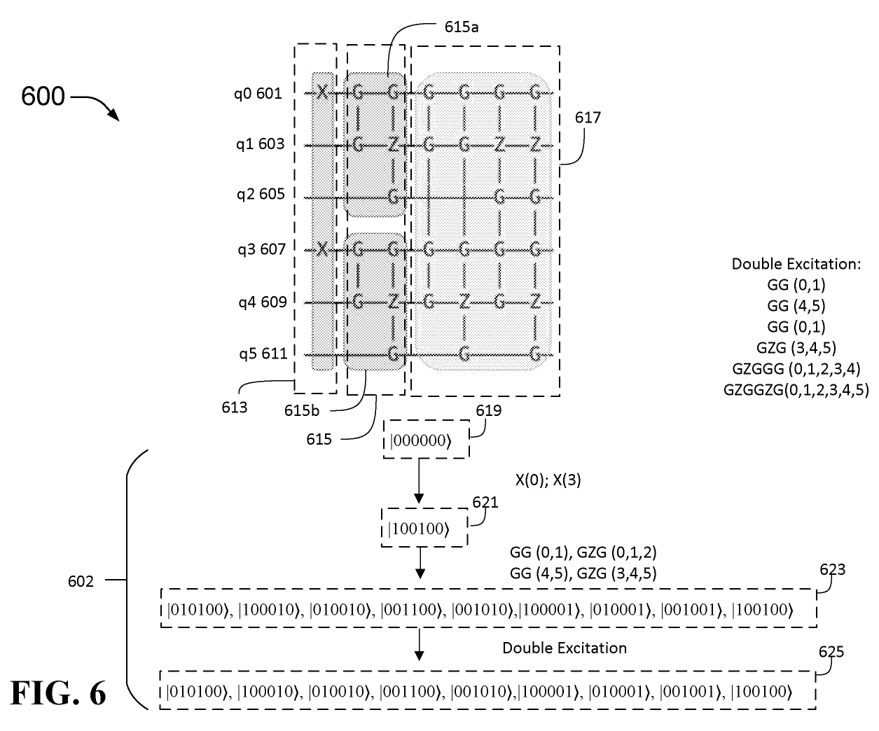

FIG. 6 llustrates a third example of performing automated symmetry verification on a quantum circuit in accordance with aspects of this disclosure. The second example 600 covers operations: Rules 1, 7, and 8.

As an example, the third example 600 shown in FIG. 6 may be a chemistry quantum circuit having six qubits 601, 603, 605, 607, 609, 611. As shown in FIG. 6, the quantum circuit has a block of single qubit gates of two X-gates 613.

Accordingly, the third example 600 will perform the following operations in order based on the different types of gates that are encountered in order. As an initial matter, as shown in 619, example 602 begins with an initial classical state, which is usually just the all-zero state. For example, in 619, the example 602 starts with the initial state of |000000⟩. Thus, the initial classical state is a single classical bitstring with all qubits initialized to zero (i.e., the all-zeros state) in this exemplary aspect.

As shown in 621, the example 602 encounters the X-gates 613 so the example 602 will apply Rule 1 (e.g., single-qubit π-rotations do not increase the number of states and only remaps the existing states by flipping the bit on the corresponding ion). For example, in 619, per Rule 1, the existing state (e.g., the initial classical state) of |000000⟩ is remapped by flipping the bit on the corresponding ion to |100100⟩ since the X-gates 613 are applied to the first qubit 601 and the fourth qubit 607.

As shown in 623, the example 602 next encounters Givens rotations 615 (e.g., a first Givens rotation from a first Fermi excitations block 615a and a second Givens rotation from a second Fermi excitation block 615b) SO the example 602 will apply Rule 7 (e.g., Givens rotations add allowed states with bits simultaneously flipped on target qubits if particle preservation is obeyed). For example, per Rule 7, the first Givens rotation in the first Fermi excitations block 615a extends the set of states in 621 from [100100) by adding another allowed state 010100), thus after that Givens rotation the set of states in 621 is extended to 100100), |010100). The second Givens rotation in the first Fermi excitations block 615a adds state |001100) to the allowed states, SO that after 615a, the set of allowed states in 621 extends to |100100), 010100), 001100). Thus, the first Fermi excitations block 615a triples the number of allowed states in 621. The second Fermi excitation block 615b does the same on the different set of qubits so that would lead to another tripling the number of allowed states. The combined effect of the first Fermi excitations block 615a and second Fermi excitation block 615b leads to a total of nine allowed states |100100), |010100), 001100), [100010), |010010), |001010), 100001), |010001), 001001).

As an example, if the example 600 begins with the state |100100⟩ and a 2q Givens rotation is applied on the first two qubits 601, 603, the allowed states are |100100⟩ and |010100⟩ because the Givens rotations can turn any state |10⟩ into a state |01⟩ and vice versa, but leaves |00⟩ and |11⟩ unchanged.

As shown in 625, the example 602 encounters a double excitation 617 so the example 602 will apply Rule 8 (Fermi excitations act as their underlying Givens rotations. In addition, all Z terms may be ignored). Both 615 and 617 represent Fermi excitations, where 615 consists of single excitations implemented using underlying 2-qubit Givens rotations, while 617 involves double excitations utilizing underlying 4-qubit Givens rotations. The absence of additional allowed states is due to the 4-qubit Givens rotation in 617 not introducing any symmetry-breaking effects beyond those already present in the 2-qubit Givens rotation within the 615 block.

Accordingly, example 602 reveals that the allowed states in the quantum circuit are: |100100⟩, |010100⟩, |100010⟩, |010010⟩, |001100⟩, |000101⟩, |100001⟩, |010001⟩, and |001001⟩. In other words, the example 602 identifies that there are nine allowed states out of 65 (e.g., 26allowed states allowed in the circuit after starting with all zero states, going through every operation according to the rules, and tracking each state. By determining all the states that are allowed in the circuit, this knowledge may help with post selection and noise reduction. Specifically, by knowing what states are allowed, then the present disclosure also determines which states are forbidden. In this way, if any forbidden states are measured on the circuit due to noise, then those states may be selected and discarded in post-processing. In this way, the quality of measured results is improved due to the determination of the forbidden states.

According to an exemplary aspect, the “re-mapping” and “generating”, as recited in connection with tracking allowed output states, correspond to two distinct categories of gate-level operations applied during automated symmetry verification. Specifically, “re-mapping” can refer to gate operations that preserve the number of tracked states in the state list without introducing any new states, while altering the bitstring representation of one or more existing tracked states. Gate operations that fall within this category of re-mapping include single-qubit -rotations (e.g., X, Y, and GPI gates) as described in Rule 1, which remap existing states by flipping a bit on the corresponding ion without increasing the number of tracked states; CNOT and multi-controlled X or Y gates as described in Rule 5, which do not add new states but instead flip target bits conditioned on the state of control bits; and SWAP gates as described in Rule 6, which do not add new states but swap bits on the target ions in each tracked state.

In contrast, the concept of “generating” refers to gate operations that introduce one or more new complementary states to the state list, thereby increasing the number of tracked states. Gate operations that fall within this category of generating include single-qubit non-π gates (e.g., Rx, Ry, R, and U3/GPI2 gates) as described in Rule 2, which add a complementary state with a bit flipped on the corresponding qubit; two-qubit XX, YY, or MS gates as described in Rule 3, which add a complementary state with bits simultaneously flipped on the target qubits; Pauli evolutions as described in Rule 4, which add a complementary state with qubits simultaneously flipped on qubits that correspond to X and Y terms; and Givens rotations (and their associated Fermi excitations) as described in Rules 7 and 8, which add complementary states with bits simultaneously flipped on target qubits in accordance with particle preservation. As should be appreciated to those skilled in the art, in certain gate sequences, both re-mapping and generating may occur in combination, as successive gates of different types are encountered during circuit traversal.

Accordingly, when the method tracks allowed output states by re-mapping and/or generating possible output states according to operations performed for each gate type of each gate, it is understood that for each gate encountered in the quantum circuit, the method applies the corresponding operation rule to the current list of tracked states: if the encountered gate corresponds to a re-mapping operation (e.g., Rules 1, 5, or 6), the tracked states are updated in place without adding new entries to the state list; and if the encountered gate corresponds to a generating operation (e.g., Rules 2, 3, 4, 7, or 8), one or more new complementary states are added to the state list based on the specific transformation defined by the gate type. The state list is initialized once at the start of the algorithm with a single all-zero classical state (e.g., |000⟩ for a three-qubit circuit or |000000⟩ for a six-qubit circuit) and is then iteratively updated as each gate in the quantum circuit is processed in sequence. The resulting state list, after all gates have been processed, defines the subset of allowed output states used for symmetry verification and error detection.

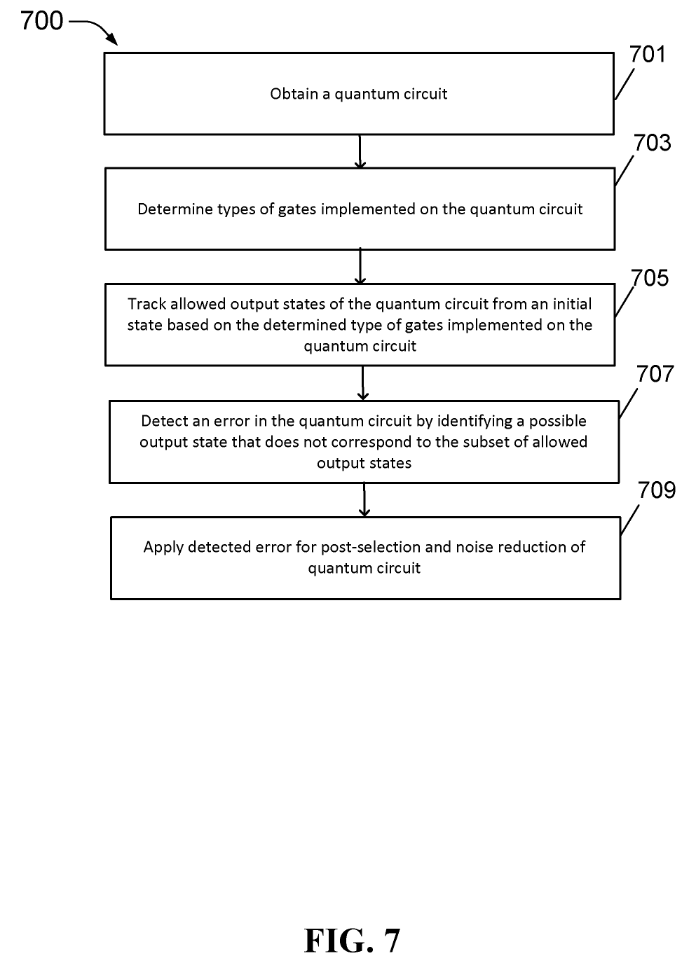

FIG. 7 illustrates an example of a method 700 performing automated symmetry verification on a quantum circuit in accordance with aspects of this disclosure.

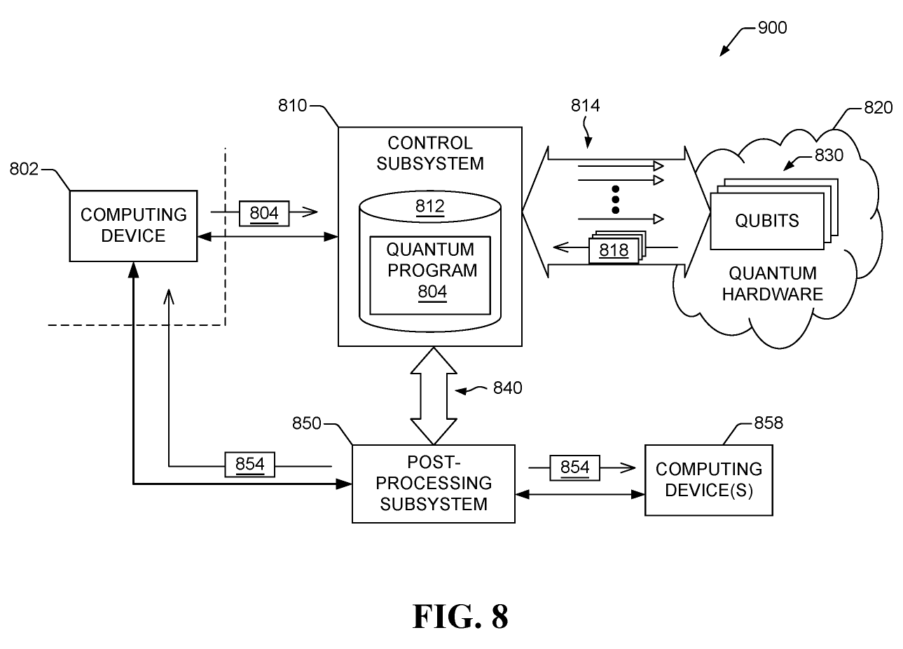

In general, it is noted that the exemplary method 700 can be implemented using the components and systems described herein, especially with respect to QIP system 200 and general controller 205 of FIG. 2 as described above and system 800 and computing device 802 of FIG. 8 as described below. The steps and algorithms described in relation to method 700 may be executed by processor 310 using algorithms components 210. In some implementations, the method 700 is performed by a processor executing code stored in a non-transitory computer-readable storage medium (e.g., memory). That is, implementing the computer-implemented method 700 can include compiling or executing, or both, one or several of the blocks included in the computer-implemented method 700, for example. To that end, each computing device can include one or multiple processors, one or multiple memory devices, other types of computing resources (such as communication interface(s), bus architectures, etc.), a combination thereof, or similar resources.

At block 701, the method 700 includes obtaining a quantum circuit with a compiled quantum program corresponding to a defined quantum computation. As an example, referring back to FIG. 4, the first example 400 may show a quantum circuit with three qubits 401, 403,405. As another example referring back to FIG. 5, the second example 500 may show a quantum circuit with three qubits 501, 503, 505. As yet another example, referring back to FIG. 6, the third example 600 may show a quantum circuit with six qubits 601, 603, 605, 607, 609, 611.

At block 703, method 700 includes determining types of gates implemented on the quantum circuit. This classification is crucial for understanding the transformations applied to qubits and their impact on symmetry verification. The key gate types identified in the document include:

Rule 1. Single-Qubit Pi-Rotations (e.g., X, Y, and GPI gates): These gates do not introduce new quantum states but instead remap existing states by flipping specific qubit bits. In some aspects, in response to a determination that a single-qubit Pi-rotation gate is implemented on the quantum circuit, the method 700 includes performing an operation comprising: not increasing a number of states, and remapping existing states by flipping a bit on a corresponding ion. In some aspects, the single-qubit Pi-rotation gate corresponds to a Pauli-X gate (X gate), Paul-Y gate (Y gate), or Gate PI (GPI gate).

As an example, referring back to FIG. 4, the first example 400 shows an application of Rule 1. Specifically, in 415, per Rule 1, the existing state (e.g., the initial classical state) of |000⟩ is remapped by flipping the bit on the corresponding ion to |100⟩ since the X-gate 407 is applied to the first qubit 401.

Rule 2. Single-Qubit Non-Pi Gates (e.g., Rx, Ry, R, U3 (GPI2) gates): These gates add complementary quantum states by flipping a bit on the respective qubit. In some aspects, in response to a determination that a single-qubit non-Pi gate is implemented on the quantum circuit, the method 700 includes performing the operation comprising adding an allowed state with a bit flipped on a corresponding qubit. In some aspects, the single-qubit non-Pi gate corresponds to a Rx gate, Ry gate, R gate, or U3 gate.

As an example, referring back to FIG. 4, the first example 400 shows an application of Rule 2. In 415, per Rule 1, the existing state (e.g., the initial classical state) of |000⟩ is remapped by flipping the bit on the corresponding ion to |100⟩ since the X-gate 407 is applied to the first qubit 401.

Rule 3. Two-Qubit Gates (e.g., XX, YY, MS gates): These gates introduce complementary states where bits are flipped simultaneously on the involved qubits. In some aspects, in response to a determination that a two-qubit gate is implemented on the quantum circuit, the method 700 includes performing the operation comprising: adding an allowed state with bits simultaneously flipped on target qubits. In some aspects, the two-qubit gates correspond to a XX, YY, or MS gates.

As an example, referring back to FIG. 4, the first example 400 shows an application of Rule 3. In 419, per Rule 3, the example 402 adds an allowed state to |100⟩ by flipping the bits on the first qubit 401 and the second qubit 403 to generate the complementary state of |010⟩ and the example 402 adds an allowed state to |110⟩ by flipping the bits on the first qubit 401 and the second qubit 403 to generate the complementary state of |000⟩.

Rule 4. Pauli evolutions (e.g., XXIIZZYYII): These operations add complementary states by flipping qubits corresponding to X and Y terms in the string. In some aspects, in response to a determination that a Pauli string is implemented on the quantum circuit, the method 700 includes performing the operation comprising: adding an allowed state with qubits simultaneously flipped on qubits that correspond to X and Y.

As an example, referring back to FIG. 5, the second example 500 shows an application of Rule 4. In 515, per Rule 4, the existing state (e.g., the classical state) of |000⟩ adds a complementary state of |101⟩ by simultaneously flipping the bits on qubits that correspond to X (e.g., first qubit 501) and Y (e.g., third qubit 505).

Rule 5. Controlled Gates (e.g., CNOT, multi-controlled X or Y gates): These do not create new quantum states, but rather conditionally flip target qubits based on control qubits. In some aspects, in response to a determination that a Controlled NOT gate (CNOT) and multi-controlled X or Y gate implemented on the quantum circuit, the method 700 includes performing the operation comprising: not adding new states and flipping target bits conditioned on a state of control bits.

As an example, referring back to FIG. 5, the second example 500 shows an application of Rule 5. In 517, per Rule 5, the example 502 does not add new states, but flips target bits conditioned on the state of control bits such that |101⟩ is re-mapped to |001⟩ because the control bit is on the first qubit 501.

Rule 6. SWAP Gates: These operations exchange qubits but do not introduce new states, preserving the overall quantum configuration. In some aspects, in response to a determination that a SWAP gate is implemented on the quantum circuit, the method 700 includes performing the operation comprising: not adding new states, and swapping bits on target ions in each state.

As an example, referring back to FIG. 5, the second example 500 shows an application of Rule 6. In 519, per Rule 6, the example 502 does not add any new states but swaps bits on the target ions in each state such that |001⟩ is re-mapped to |010⟩ since the target ions are on the first qubit 503 and the third qubit 505.

Rule 7. Givens Rotations: obeying particle preservation, they introduce complementary states by flipping qubits according to predefined symmetry rules. For example, a two-qubit Givens rotation preserves states 00 and 11 but flips 01 to 10 and vice versa. In some aspects, in response to a determination that a Givens rotation is implemented on the quantum circuit, the method 700 includes performing the operation comprising: adding allowed states with bits simultaneously flipped on target qubits based on obeying particle preservations.

As an example, referring back to FIG. 6, the third example 600 shows an application of Rule 7. In 621, per Rule 7, the existing states of |100100⟩ will add a first allowed state of |010100⟩ based on the first Givens rotation in the first Fermi excitations block 615a. Next, the existing state of |011000⟩ will add a second allowed state of |100010⟩ based on the second Givens rotation in the second Fermi excitation block 615b. Subsequently, the example 602 may add a third allowed state |010010⟩ due to consideration of both the first Givens rotation in the first Fermi excitations block 615a and the second Givens rotation in the second Fermi excitation block 615b. The example 602 then adds additional allowed states of |001100⟩, |001010⟩, |100001⟩, |010001⟩, and |001001⟩ from different combinations of the first Givens rotation in the first Fermi excitations block 615a and the second Givens rotation in the second Fermi excitation block 615b.

Rule 8. Fermi Excitations: These operations function similarly to the underlying Givens rotations, while Z terms can be ignored. In some aspects, the method 700 includes ignoring Z terms, and associating Fermi excitations as their underlying Givens rotations.

Specifically, in block 703, the method 700 systematically determines which of these gate types are present in the quantum circuit. This classification allows for automated symmetry verification by predicting the subset of allowed output states. By analyzing the types of gates implemented, method 700 can track how quantum states evolve and ensure that only physically valid states are considered, significantly reducing errors in quantum computations.

At block 705, the method 700 includes tracking allowed output states of the quantum circuit from an initial state based on the determined type of gates implemented on the quantum circuit by: re-mapping and/or generating possible output states according to operations performed for each gate type of gate implemented on the quantum circuit. Moreover, each operation starts with initiating a classical zero state and tracking each generated possible output state when performing an operation corresponding to each type of gate implemented on the quantum circuit to determine a subset of possible output states.

In this aspect, the tracked output states, the allowed output states, and the subset of allowed output states refer to sets of classical bitstrings that are derived through the gate-by-gate symmetry analysis described herein. These states can be determined, for example, through classical computation by applying the operation rules (e.g., Rules 1–8) to the initial all-zero state as each gate in the quantum circuit is sequentially processed, without executing the quantum circuit on quantum hardware. In other words, the tracked or allowed output states represent the theoretically permissible outcomes of the quantum circuit as constrained by the symmetries identified during automated circuit exploration. Any classical bitstring that is not a member of this subset of allowed output states can be considered a forbidden state, which is a state that should not be observed absent errors in the quantum circuit. As described herein, by determining all the states that are allowed in the circuit, the present disclosure also determines which states are forbidden. In turn, these results can be used for post-selection and noise reduction. In contrast, measured output state (which can also be considered an “observed output state”) in the context of detecting an error in the quantum circuit, refers to the actual bitstring outcomes obtained when the quantum circuit is executed on quantum hardware (e.g., QIP system 200 of FIG. 2) and the qubits are measured.

As next shown at block 707, method 700 includes detecting an error in the quantum circuit by identifying a possible output state that does not correspond to the subset of allowed output states. This process relies on automated symmetry verification, which ensures that only valid quantum states—determined by the circuit's initial conditions and applied gate operations—are considered. In other words, due to imperfections inherent in quantum hardware (e.g., control errors, qubit decoherence, and gate infidelities), a measured output state may include bitstrings that do not belong to the subset of allowed output states derived from the symmetry analysis. Accordingly, in the error detection step, each measured or observed output state obtained from actual circuit execution is compared against the subset of allowed output states. If a measured output state does not correspond to any state in the subset of allowed output states (i.e., it is a forbidden state), that measured output state is identified as erroneous and may be discarded in post-processing.

For example, as shown at block 709, the method includes applying the detected error in the quantum circuit for post-selection and noise reduction of the quantum circuit. Specifically, once the method 700 has identified one or more measured output states that do not correspond to the subset of allowed output states (e.g., the forbidden states described above) at block 707, the method 700 may apply this determination in post-processing by selecting and discarding the forbidden states from the set of measured results obtained from execution of the quantum circuit on quantum hardware. By filtering out the erroneous bit strings that arise due to quantum noise, gate imperfections, or qubit decoherence, the exemplary method can improve the fidelity of the remaining quantum results and reduce the cumulative effect of hardware-level error propagation. In this way, the automated symmetry verification of the exemplary aspects described herein enhances the performance and reliability of quantum algorithms, particularly in noisy intermediate-scale quantum (NISQ) devices, by ensuring that only physically valid states, as determined by the symmetry restrictions identified during circuit exploration, are retained for further analysis or computation. As a result, the method 700 optimizes resource usage and reduces computational complexity in post-processing while maintaining the integrity of the valid quantum states.

In this way, by leveraging known symmetries and transformations, the method systematically filters out erroneous bit strings that arise due to quantum noise, gate imperfections, or decoherence. If an output state does not align with the expected symmetry-restricted subset, it is flagged as an error. The automated nature of this detection enhances the circuit’s reliability, reduces computational overhead in post-processing, and ensures the physical validity of quantum computations by eliminating erroneous states before further analysis.

In some examples, method 700 may include generating the quantum circuit by compiling the quantum program. This compilation process involves decomposing abstract quantum algorithms into a sequence of gate operations tailored to the specific architecture of the quantum processor. During compilation, optimization techniques are applied to reduce gate count, minimize errors, and preserve essential symmetries that play a crucial role in post-processing verification. By structuring the circuit to adhere to the constraints of the underlying quantum hardware, the method ensures that symmetry restrictions are maintained, facilitating automated symmetry verification and error reduction. Additionally, compiling the quantum program helps in selecting the most efficient gate implementations, balancing fidelity, coherence time, and resource constraints to improve the overall performance and accuracy of quantum computations. As an example, this step is essential for practical quantum applications, including VQE circuits and quantum chemistry simulations, where circuit efficiency and correctness directly influence computational outcomes.

FIG. 8 illustrates an example of a QIP system in accordance with aspects of this disclosure. The example QIP system 800 shown in FIG. 8 includes a control subsystem 810 that can receive a quantum program 804 from a computing device 802 that can be remotely located relative to the example QIP system 800 and is functionally coupled (e.g., communicatively coupled) to the control subsystem 810. The computing device 802 can send data defining the quantum program 804 to control subsystem 810 for execution in quantum hardware 820, determining qubit placement in the quantum circuit and configuring quantum gates, as described herein. As is indicated by dashed lines, the computing device 802 can be external to the example QIP system 800. For example, the computing device 802 can be a user device (e.g., a classical computer) of an end-user of the QIP system 800. The control subsystem 810 can retain the quantum program 804 in one or more memory devices 812. The quantum program 804 corresponds to a defined quantum computation. The defined quantum computation can be an n-qubit computation, for example. The quantum program 804 can include a quantum circuit (and, in some cases, sub-circuits) representing a quantum algorithm associated with quantum computation. Examples of the quantum algorithm include a variational quantum algorithm, a machine-learning algorithm, a Fourier transform algorithm, or the like. In addition, the quantum circuit generated by the quantum program 804 can include the circuits (e.g., as shown in FIGS. 4-6) as described herein.

The control subsystem 810 can be functionally coupled to quantum hardware 820 via multiple links 814 that permits the exchange of data and/or controls signal between the control subsystem 810 and the quantum hardware 820. The quantum hardware 820 can embody or can include one or more quantum computers. In some cases, the quantum hardware 820 embodies a cloud-based quantum computer. In other cases, the quantum hardware 820 embodies, or includes a local quantum computer. Regardless of its spatial footprint, the quantum hardware 820 includes multiple qubits 830 arranged in a particular layout. Each qubit of the qubits 830 (e.g., computation and ancilla qubits) can be coupled to an environment and/or to one another. Such coupling(s) decoheres and relaxes quantum information contained in the qubit. Thus, the quantum hardware 820 can be noisy. The type of multiple links can be based on the type of qubits 830 used by the quantum hardware 820 for computation. In some cases, the multiple links 814 can include wireline links or optical links, or a combination of both.

As described herein, the qubits 830 can include atomic qubits assembled in an atom-trap. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, or similar ions. The atomic-qubits in such cases can be confined within an ion-trap (e.g., the trap 270 (FIG. 2) and can be assembled in a linear arrangement (such as the linear crystal or chain 110 (FIG. 1)). In other implementations, the qubits 830 can include solid-state devices of one of several types. Such devices can be embodied in, for example, Josephson junction devices, semiconductor quantum-dots, or defects in a semiconductor material (such as vacancies in Si and Ge, or nitrogen-vacancy centers in diamond).

The control subsystem 810 can cause the quantum hardware 820 to execute the quantum circuit and/or sub-circuits as described herein. In response, the control subsystem 810 can receive measurement data 818 indicative of the outputs (e.g., tracked allowed output states and possible output states), for example. Because the quantum computation can be performed in two or more qubits, a measurement outcome can be represented as a bitstring representing a particular target output state given a particular set of qubits involved in a quantum computation. The control subsystem 810 can supply at least a portion of the measurement data 818 (e.g., ancilla qubit) to components of the control subsystem 810 and/or other subsystems (e.g., post-processing subsystem 850).

The control subsystem 810 also can be functionally coupled to a post-processing subsystem 850 via a communication architecture 840. The communication architecture 840 can include wirelines links, wireless links, network devices (such as gateway devices, servers, and the like), or a combination thereof. The post-processing subsystem 850 can apply one or several post-processing techniques as described herein to measurements received from the quantum hardware 820. By applying such techniques, the post-processing subsystem 850 can generate a result 854 of a quantum computation executed by the quantum hardware. The post-processing subsystem 850 can send the result 854 (or data indicative of the result 854) to the computing device 802 and/or other computing device(s) 858. The post-processing subsystem 850 also can cause the computing device 802 to present the result 854 in a particular way. For example, the post-processing subsystem 850 can direct the computing device 802 to present a user interface including the result 854.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

In general, it is noted that the foregoing description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of performing automated symmetry verification on a quantum circuit, comprising:
obtaining a quantum circuit with a compiled quantum program corresponding to a defined quantum computation;
determining a gate type for each gate implemented by the quantum circuit;
tracking allowed output states of the quantum circuit from an initial state based on the determined gate type of each gate implemented by the quantum circuit by:
re-mapping and/or generating possible output states according to operations performed for each gate type of each gate implemented by the quantum circuit, wherein each operation starts with initiating a classical all-zero state, and
tracking each of the possible output states when performing an operation corresponding to each gate type of each gate implemented by the quantum circuit to determine a subset of possible output states; and
detecting an error in the quantum circuit by identifying a possible output state of the tracked possibly output states that does not correspond to an allowed output state of the tracked allowed output states of the quantum circuit.

2. The method of claim 1, wherein, in response to determining that a gate type of at least one gate is a single-qubit Pi-rotation gate implemented by the quantum circuit, performing an operation comprising:
not increasing a number of states, and
remapping existing states by flipping a bit on a corresponding ion.

3. The method of claim 2, wherein the single-qubit Pi-rotation gate corresponds to a Pauli-X gate (X gate), Paul-Y gate (Y gate), or Gate PI (GPI gate).

4. The method of claim 1, wherein, in response to determining that a gate type of at least one gate is a single-qubit Pi-rotation gate implemented by the quantum circuit, performing the operation comprising adding an allowed state with a bit flipped on a corresponding qubit.

5. The method of claim 4, wherein the single-qubit non-Pi gate corresponds to a Rx gate, Ry gate, R gate, or U3 gate.

6. The method of claim 1, wherein, in response to determining that a gate type of at least one gate is a two-qubit gate implemented by the quantum circuit, performing the operation comprising adding an allowed state with bits simultaneously flipped on target qubits.

7. The method of claim 6, wherein the two-qubit gate correspond to a XX, YY, or MS gates.

8. The method of claim 1, wherein, in response to determining that a Pauli string is implemented on the quantum circuit, performing the operation comprising adding an allowed state with qubits simultaneously flipped on qubits that correspond to X and Y.

9. The method of claim 1, wherein, in response to determining that a gate type of at least one gate is a Controlled NOT gate (CNOT) and multi-controlled X or Y gate implemented on the quantum circuit, performing the operation comprising:
not adding new states, and
flipping target bits conditioned on a state of control bits.

10. The method of claim 1, wherein, in response to determining that a gate type of at least one gate is a SWAP gate is implemented on the quantum circuit, performing the operation comprising:
not adding new states, and
swapping bits on target ions in each state.

11. The method of claim 1, wherein, in response to determining that a Givens rotation is implemented on the quantum circuit, performing the operation comprising adding allowed states with bits simultaneously flipped on target qubits based on obeying particle preservations.

12. The method of claim 11, wherein the operation further comprises ignoring Z terms, and associating Fermi excitations as the respective underlying Givens rotations.

13. The method of claim 1, further comprising generating the quantum circuit by compiling the quantum program.

14. A computing system, comprising:
at least one processor;
at least one memory devices storing processor-executable instructions, that in response to being executed by the at least one processor, configures the at least one processor to:
obtain a quantum circuit with a compiled quantum program corresponding to a defined quantum computation;
determine a gate type for each gate implemented by the quantum circuit;
track allowed output states of the quantum circuit from an initial state based on the gate types of each gate implemented by the quantum circuit by:
re-mapping and/or generating possible output states according to operations performed for each gate type of each gate implemented by the quantum circuit, wherein each operation starts with initiating a classical all-zero state, and
tracking each of the possible output states when performing an operation corresponding to each gate type of each gate implemented by the quantum circuit to determine a subset of possible output states; and
detect an error in the quantum circuit by identifying a possible output state of the tracked possibly output states that does not correspond to an allowed output state of the tracked allowed output states of the quantum circuit.

15. The computing system of claim 14, wherein the at least one processor is further configured to, in response to a determination that the gate type of at least one gate is a single-qubit Pi-rotation gate that is implemented on the quantum circuit, perform an operation comprising not increasing a number of states, and remapping existing states by flipping a bit on a corresponding ion.

16. The computing system of claim 15, wherein the single-qubit Pi-rotation gate corresponds to a Pauli-X gate (X gate), Paul-Y gate (Y gate), or Gate PI (GPI gate).

17. The computing system of claim 14, wherein the at least one processor is configured to, in response to a determination that the gate type of at least one gate is a single-qubit non-Pi gate that is implemented on the quantum circuit, perform the operation comprising adding an allowed state with a bit flipped on a corresponding qubit.

18. The computing system of claim 17, wherein the single-qubit non-Pi gate corresponds to a Rx gate, Ry gate, R gate, or U3 gate.

19. The computing system of claim 14, wherein the at least one processor is configured to generate the quantum circuit by compiling the quantum program.

20. A quantum information processing system (QIP) system, comprising:
at least one processor; and
at least one memory device storing processor-executable instructions that, in response to being executed by the at least one processor, cause the QIP system to:
obtain a quantum circuit with a compiled quantum program corresponding to a defined quantum computation;
determine a gate type for each gate implemented by the quantum circuit;
track allowed output states of the quantum circuit from an initial state based on the gate types of each gate implemented by the quantum circuit by:
re-mapping and/or generating possible output states according to operations performed for each gate type of each gate implemented by the quantum circuit, wherein each operation starts with initiating a classical all-zero state, and
tracking each of the possible output states when performing an operation corresponding to each gate type of each gate implemented by the quantum circuit to determine a subset of possible output states; and
detect an error in the quantum circuit by identifying a possible output state of the tracked possibly output states that does not correspond to an allowed output state of the tracked allowed output states of the quantum circuit.
